(19) United States
(12) Patent Application Publication
(10) Pub. No.: US 2011/0273659 A1
(43) Pub. Date: Nov. 10, 2011

(54) LIQUID CRYSTAL MIRROR WITH DISPLAY

(75) Inventor: Justin E. Sobecki, Rockford, MI (US)

(73) Assignee: MAGNA MIRRORS OF AMERICA, INC., Holland, MI (US)

(21) Appl. No.: 13/102,263

(22) Filed: May 6, 2011

Related U.S. Application Data
(60) Provisional application No. 61/332,375, filed on May 7, 2010.

(51) Int. Cl. B60R 1/08; G02F 1/1335

(52) U.S. Cl. 349/195

(57) ABSTRACT

A variable reflectance vehicular mirror reflective element assembly includes a front substrate, an intermediate substrate and a rear substrate, with a first liquid crystal polarization unit disposed between the rear surface of the front substrate and the front surface of the intermediate substrate and a second liquid crystal polarization unit disposed between the rear surface of the intermediate substrate and the front surface of the rear substrate. When the liquid crystal polarization units are unpowered, the reflective element assembly substantially specularly reflects light incident thereon so as to appear specularly mirror-like to a driver of the vehicle viewing the front surface of the front substrate. When the liquid crystal polarization units are electrically powered, they change from being highly specularly reflective to substantially transmitting visible light therethrough. When powered, the liquid crystal polarization units cooperate or combine to provide an anti-glare, low reflecting mirror for viewing by the vehicle driver.

### CROSS REFERENCE TO RELATED APPLICATIONS

The present application the filing benefit of U.S. provisional application Ser. No. 61/332,375, filed May 7, 2010, which is hereby incorporated herein by reference in its entirety.

### FIELD OF THE INVENTION

The present invention relates generally to reflective element assemblies for rearview mirrors of vehicles and, more particularly, to liquid crystal reflective element assemblies for rearview mirrors of vehicles.

### BACKGROUND OF THE INVENTION

Automotive mirror reflective element assemblies may comprise prismatic or electro-optic (such as, for example, electrochromic) or liquid crystal reflective element assemblies. Examples of electrochromic are described in U.S. Pat. Nos. 7,310,178; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407; 4,902,108 and/or 4,712,879, which are hereby incorporated herein by reference in their entireties. Liquid crystal reflective assemblies are also known in the art and typically operate in a similar manner to liquid crystal displays. Examples of such liquid crystal reflective assemblies are described in U.S. Pat. Nos. 4,848,878; 4,161,653; 4,201,451; 4,971,425; 6,859,245; 5,841,496, 6,144,430, 6,717,639 and 6,784,956, which are hereby incorporated herein by reference in their entireties. It is known to provide a display behind a reflective element assembly, whereby the display is viewable through a transflective mirror reflector of the reflective element assembly when activated and substantially not discernible or viewable through the transflective mirror reflector of the reflective element assembly when the display is not activated.

### SUMMARY OF THE INVENTION

The present invention provides a liquid crystal reflective cell element assembly for an automotive rearview mirror assembly that includes a liquid crystal medium that is selectively and locally addressable or energizable to provide locally enhanced transmission of light through localized regions of the reflective element assembly, while providing, at other regions, a high specular reflectivity that is electrically variable to a low reflecting anti-glare state.

According to an aspect of the present invention, a variable reflectance vehicular mirror reflective element assembly comprises a front substrate having a front surface that generally faces a driver of a vehicle equipped with a mirror assembly that incorporates the rearview mirror reflective element assembly, an intermediate substrate having a front surface and a rear surface, and a rear substrate having a front surface and a rear surface. The front substrate has a rear surface opposite the front surface, with the rear surface of the front substrate having a transparent electrically conductive coating disposed thereat, while the front surface of the intermediate substrate has a conductive coating disposed thereat and the rear surface of the intermediate substrate has a conductive coating disposed thereat, and the front surface of the rear substrate has a conductive coating disposed thereat. A first liquid crystal polarization unit or element is disposed between the rear surface of the front substrate and the front surface of the intermediate substrate, and a second liquid crystal polarization unit or element is disposed between the rear surface of the intermediate substrate and the front surface of the rear substrate. The first liquid crystal polarization unit or element, when unpowered, functions to polarize light in a first direction and the second liquid crystal polarization unit or element, when unpowered, functions to polarize light in a second direction, with the second direction being generally opposite the first direction. When the first and second liquid crystal polarization units are unpowered, the reflective element assembly substantially specularly reflects light incident thereon so as to appear specularly mirror-like to a person viewing the front surface of the front substrate when the reflective element assembly is normally mounted in the equipped vehicle. However, when the first and second liquid crystal polarization units are electrically powered, they change from being highly specularly reflective to substantially transmitting visible light therethrough. Thus, in the powered condition, the driver viewing the front surface essentially sees through both liquid crystal polarization units or elements to a light absorbing layer (such as a dark or black coating or film or layer) that is established or disposed at or provided at the rear substrate (such as at the front or rear surface of the rear substrate) and behind the two liquid crystal polarization units. Thus, when powered, the tandem combination of liquid crystal polarization units provides an anti-glare, low reflecting mirror for viewing by the driver of the vehicle.

Optionally, the first liquid crystal polarization unit, when unpowered, may polarize light passing therethrough in a right or left circular direction and the second liquid crystal polarization unit, when unpowered, may polarize light passing therethrough in a left or right circular direction. A display device may be locally disposed behind the rear substrate of the reflective element assembly and may be operable to display information, wherein the first and second liquid crystal polarization units are locally operated to, when powered, substantially transmit light therethrough so display information emitted by the display device is viewable through the reflective element assembly by a driver of the equipped vehicle. The light absorbing layer is not established at the rear substrate in the localized area at which the display device is disposed.

According to another aspect of the present invention, a variable reflectance vehicular mirror reflective element assembly comprises a front substrate having a front surface that generally faces a driver of a vehicle equipped with a mirror assembly that incorporates the rearview mirror reflective element assembly, and a rear substrate having a front surface and a rear surface. The front substrate has a rear surface opposite the front surface, and the rear surface of the front substrate has a transparent electrically conductive coating disposed thereat, and the front surface of the rear substrate has a conductive coating disposed thereat. A liquid crystal polarization unit or element is disposed between the rear surface of the front substrate and the front surface of the rear substrate. The liquid crystal polarization unit or element, when unpowered, functions to polarize light passing therethrough. When the liquid crystal polarization unit is unpowered, the reflective element assembly substantially specularly reflects light incident thereon so as to appear specularly mirror-like to a person viewing the front surface of the front substrate when the reflective element assembly is normally mounted in a vehicle. However, when the liquid crystal polarization unit or element is electrically powered, it changes from being specularly reflective to substantially transmitting visible light therethrough. Thus, in the powered condition, the driver viewing the front surface essentially sees through the liquid crystal polarization unit or element, such as to a light absorbing layer (such as a dark or black coating or film or layer) that is established or disposed at or provided at the rear and behind the liquid crystal polarization unit. Thus, when powered, the liquid crystal polarization unit or element provides an anti-glare, low reflecting mirror for viewing by the driver of the vehicle.

Optionally, a display device may be disposed behind the rear substrate and operable to display information, wherein the liquid crystal polarization unit is operable to, when powered, substantially transmit light therethrough so display information emitted by the display device is viewable through the reflective element assembly by a driver of the vehicle. Optionally, the rear substrate may comprise a display device (such as a backlit liquid crystal display device or the like) operable to display information when activated, and wherein a front surface of the display device has the transparent electrically conductive coating disposed thereat.

These and other objects, advantages, purposes and features of the present invention will become apparent upon review of the following specification in conjunction with the drawings.

### BRIEF DESCRIPTION OF THE DRAWINGS

FIG. 1 is a sectional view of a reflective element assembly in accordance with the present invention;

FIG. 2 is a front plan view of the reflective element assembly of FIG. 1;

FIG. 3 is a graph showing the transmissivity and reflectivity ranges for electrochromic and liquid crystal reflective element assemblies;

FIG. 4 is a sectional view of another reflective element assembly in accordance with the present invention;

FIG. 5 is a sectional view of another reflective element assembly in accordance with the present invention; and

FIG. 6 is a sectional view of another reflective element assembly in accordance with the present invention.

### DESCRIPTION OF THE PREFERRED EMBODIMENTS

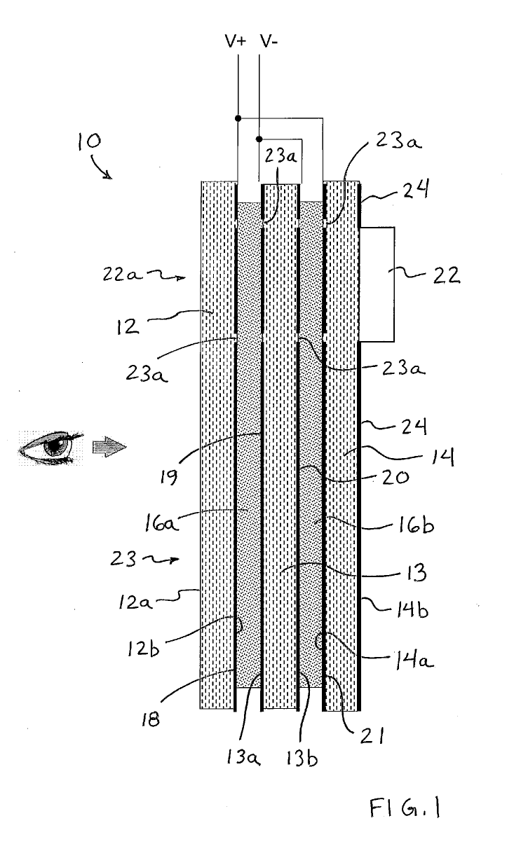

Referring now to the drawings and the illustrative embodiments depicted therein, a liquid crystal reflective element assembly or cell 10 for an interior or exterior rearview mirror assembly of a vehicle includes a first or front substrate or glass element 12 and a second or intermediate substrate or glass element 13 and a third or rear substrate or glass element 14 (FIGS. 1 and 2). The intermediate substrate 13 is spaced from the front substrate, with a first liquid crystal medium or light polarization unit 16a established or sandwiched between the substrates 12, 13 and in contact with conductive or semi-conductive layers 18, 19 (described below) established at the cavity facing surfaces 12b, 13a of the front and intermediate substrates 12, 13, respectively. Also, the rear reflective element substrate 14 is spaced from and disposed behind the intermediate substrate 13, with a second liquid crystal medium or light polarization unit 16b sandwiched between the substrates 13, 14 and in contact with conductive or semi-conductive layers 20, 21 (described below) established at the cavity facing surfaces 13b, 14a of the intermediate and rear substrates 13, 14, respectively. A voltage is selectively applied to the conductive layers 18, 19, 20, 21 to selectively energize the liquid crystal media or polarization units 16a, 16b to adjust the reflectivity of light incident on the reflective element assembly and the transmissivity of light through the reflective element assembly, as discussed below. Thus, the electrical powering of the liquid crystal polarization units (typically done by high DC voltage) affects the reflective properties of the tandem combination of the liquid crystal polarization units of the mirror reflective element rather than, as in prior art devices, having powering of the device reduce the visible light level reaching a reflective surface or coating of a rear substrate of a conventional electro-optic mirror reflective element assembly or cell. In the illustrated embodiment, the reflective element assembly 10 includes a display device 22 disposed behind the rear substrate 14, whereby light emanating from the display device is viewable through the substrates and liquid crystal polarization units when the display device is activated and when the liquid crystal polarization units are powered, as also discussed below. The reflective element assembly may utilize aspects of the liquid crystal mirror assemblies described in U.S. Pat. No. 6,859,245, which is hereby incorporated herein by reference in its entirety, and/or the liquid crystal reflective element assembly may utilize aspects of the mirror assemblies that are commercially available from Kent Optronics, Inc, of Hopewell Junction, N.Y.

As shown in FIG. 1, the reflective element assembly or cell 10 includes front substrate 12, intermediate substrate 13 and rear substrate 14, with the liquid crystal polarization units 16a, 16b disposed between respective opposed surfaces (and sealed or contained within the interpane gap or cavity between the glass substrates 12, 13 and within the interpane gap or cavity between the glass substrates 13, 14). The front substrate 12 has a front surface 12a (that faces generally towards a driver of a vehicle when the mirror assembly is normally mounted in the vehicle) and a rear surface 12b, with a transparent conductive coating 18 (such as an indium tin oxide (ITO) coating or the like) established at rear surface 12b, while the intermediate substrate 13 has a front surface 13a with a transparent conductive coating 19 (such as an indium tin oxide (ITO) coating or the like) established thereat, and a rear surface 13b with a transparent conductive coating 20 (such as an indium tin oxide (ITO) coating or the like) established thereat. Also, the rear substrate 14 has a front surface 14a (facing the interpane cavity and liquid crystal medium disposed between the intermediate and rear substrates) and a rear surface 14b, with a transparent conductive coating 20 (such as an indium tin oxide (ITO) coating or the like) established at the front surface 14a. Optionally, and as shown in FIG. 1, a dark or black or opaque or substantially opaque light absorbing layer or coating or film or element 24 may be disposed at rear surface 14b of rear substrate 14, and may substantially cover or encompass the rear surface of the rear substrate except at the location or locations where the display element 22 or other display elements or illumination sources or photosensors or cameras or the like may be disposed behind the reflective element and viewing or emitting light through the reflective element.

The liquid crystal polarization units comprise polarization units that, when unpowered, allow a respectively polarized light to pass therethrough, while limiting transmission of other light. For example, when unpowered, the polarization units together function to reflect light and the properties of the liquid crystal material is selected to provide the desired specular reflectivity (such as a silvery mirror-reflector type or color) of light reflecting from the liquid crystal units and reflective element assembly. When powered, the polarizing units are energized, and the polarizing effect of the units is impacted so that transmission of light therethrough is impacted or reduced or substantially reduced (depending on the degree of voltage applied to the unit).

For example, when unpowered, one of the units may function to polarize light in a first circular manner (such as, for example, a clockwise direction as viewing the unit from the front of the mirror reflective element), while the other unit may polarize light in a second opposite circular manner (such as, for example, a counter-clockwise direction as viewing the unit from the front of the mirror reflective element) when unpowered. For example, the front liquid crystal polarization unit 16a, when unpowered, may function to polarize or convert light into right-handed circularly polarized light, while the rear liquid crystal polarization unit 16b, when unpowered, may function to polarize or convert light into left-handed circularly polarized light. Thus, the combination of opposite polarization of light functions to effectively cancel out the light and limit or greatly reduce transmission of light through the dual polarization unit mirror reflective element assembly.

Thus, when unpowered, the polarization units polarize light in opposite manners (such as right handed circularly polarized light and left handed circularly polarized light) and thus do not allow light to pass through the combination of units. The reflective element thus specularly reflects light incident thereon, and preferably reflects at least about 70 percent of light incident thereon, more preferably at least about 80 percent of light incident thereon, and more preferably at least about 90 percent of light incident thereon. Thus, when the reflective element is unpowered, the reflective element, to a person viewing the reflective element from its front surface (such as when the mirror assembly and reflective element are normally mounted in a vehicle), appears to comprise a metal reflector and appears mirror-like. This is due to the selection of the liquid crystal materials, and the materials may be selected to provide the desired or appropriate or selected color or tint when in the reflecting or non-transmitting state. When it is desired or appropriate to dim or reduce the reflectivity of the reflective element (such as responsive to a glare sensor or the like of the mirror assembly), a voltage may be applied to the reflective element conductive coatings to reduce the polarization of the units and thus to allow some light to pass through the reflective element and not reflect off the liquid crystal elements, thereby providing a variable reflectance mirror for night time driving conditions and the like.

When the reflective element is powered (such as by applying a voltage at the respective conductive layers 18, 19, 20, 21), the liquid crystal polarization units 16a, 16b function to not polarize light passing therethrough (or at least to reduce the opposite polarization so as to pass some light through the reflective element assembly). Thus, light (such as visible light and near infrared light and infrared light) passes through the powered polarization units and the substrates so that light can pass or transmit from the display device through the substrates and polarization units so as to be viewable by a person viewing the reflective element assembly from its front surface. Preferably, when fully powered, the reflective element is at least about 60 percent transmissive of light therethrough, and more preferably about 70 percent transmissive of light therethrough, and more preferably about 80 percent or more transmissive of light therethrough. The applied operating voltage may comprise a switched DC voltage (such as 100V to 200V), with an operating current of around 50 mA (or more or less), and with a switching time of the liquid crystal polarization units (the time to switch or change from the reflective or polarized state to the transmissive or unpolarized state) of less than about 100 msec (but could be more or less while remaining within the spirit and scope of the present invention). The operating temperatures of the reflective element assembly may be in the range of about −50 degrees C. to about 150 degrees C. or thereabouts, and thus the reflective element assembly is suitable for use in automotive rearview mirror applications. The polarization units may be powered independently or in tandem, depending on the particular application and desired performance of the reflective element assembly.

By varying the voltage applied to the conductive layers 18, 19, 20, 21, the degree of polarization of the polarization units can be varied and, thus, the degree of transmissivity and reflectivity properties of the mirror reflective element can be varied. For example, a reduced transmissivity setting may be preferred during daylight conditions, so that the reflectivity is enhanced, while an increased transmissivity setting (partially to fully powered) may be preferred during night time driving conditions, such as for reducing glare and the like at the mirror from headlamps of trailing vehicles behind the equipped vehicle. When the display device is activated, the transmissivity of the reflective element assembly (at least in the localized area at which the display is disposed) may be increased to facilitate appropriate or suitable transmission of light from the display element through the reflective element assembly so as to be viewable by the driver or occupant of the vehicle.

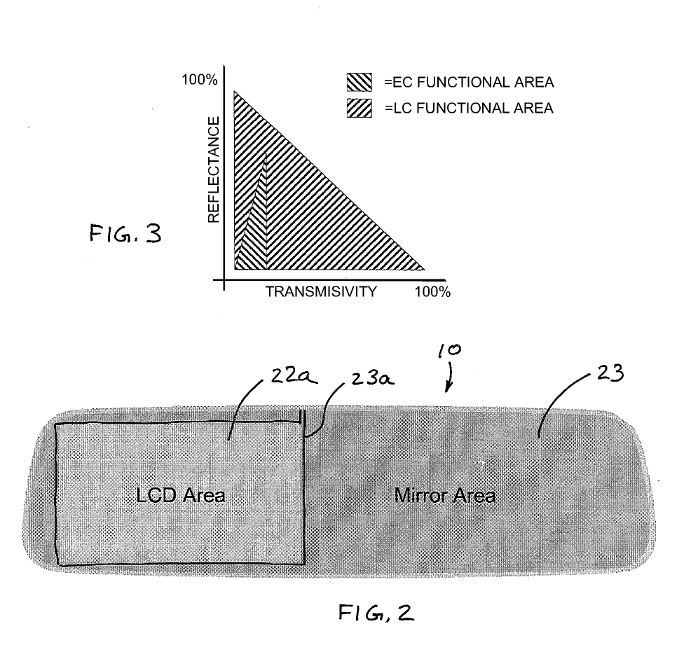

Thus, the liquid crystal reflective element assembly of the present invention provides enhanced transmissive qualities as compared to known electrochromic devices (which typically provide for less than about 40 percent transmission of visible light therethrough). For example, and with reference to FIG. 3, the properties and operation of the liquid crystal reflective element assembly of the present invention provide enhanced ranges of reflectance of light incident thereon and transmissivity of light therethrough as compared to the range of such reflectance and transmissivity achieved by known electrochromic mirror reflective element assemblies or cells. Thus, the display device 22 disposed rearward of and behind the reflective element may emanate sufficient light through the reflective element substrates and liquid crystal polarization units for adequate viewing by the driver or occupant of the vehicle, without requiring high intensity light emitting diodes and/or the like, such as are preferable in electrochromic mirror applications.

Optionally, portions of the reflective element may be selectively energizable (while other portions may be unenergized or unpowered so as to be in their reflective state). For example, and with reference to FIGS. 1 and 2, a display area 22a at and behind which the display 22 is disposed may be selectively powered to enhance transmission of light through that area or region of the reflective element 10, while the remaining area or areas 23 of the mirror reflective element reflect visible light incident thereon. Such a selective or localized accessing or energizing of the display area may be achieved by creating one or more electrically isolated conductive layer portions at one or more of the surfaces 12b, 13a, 13b, 14a of the substrates 12, 13, 14. For example, a deletion line 23a (FIGS. 1 and 2) may be established through, for example, each of the transparent conductive coatings or layers 18, 19, 20, 21 or through, for example, one of the conductive layers at the first liquid crystal polarization unit and one of the conductive layers at the second liquid crystal polarization unit, such as for example, through the transparent conductive coating or layer 19 at surface 13a of intermediate substrate 13 and the transparent conductive coating or layer 21 at surface 14a of rear substrate 14, so that the areas circumscribed by the deletion lines may be individually accessible to unpolarize or depolarize the respective portions or regions of the units 16a, 16b, respectively, so as to allow light emanating from the display device to pass through those portions of the reflective element assembly for viewing by the driver or occupant of the vehicle when the reflective element assembly and mirror assembly are normally mounted in the vehicle. Such deletion lines and laser etching of the transparent conductive coatings may be established utilizing aspects of the mirror assemblies described in U.S. Pat. Nos. 7,274,501; 7,184,190 and/or 7,255,451, which are hereby incorporated herein by reference in their entireties. The transparent conductive layers may include portions or electrically isolated traces or busbars or the like that extend from and are electrically conductively connected to or in electrical conductive continuity with the isolated areas or regions and that are accessible at or near the perimeter regions of the substrates so as to be electrically connected to the power source and/or control of the mirror assembly or vehicle. Thus, one or more of the portions of the reflective element may be selectively powered to allow for reduced reflectivity at and transmission of light through the energized portion or portions (for example, only the display area or region may be energized to allow for light from the display to pass through the substantially clear or non-reflective portion of the reflective element in front of the display, or multiple or all of the display areas or regions may be energized to provide a dimming function to the mirror reflective element, such as during nighttime driving conditions where glare is detected at the mirror).

Optionally, for example, multiple displays may be provided behind the reflective element assembly, with each display area of the reflective element assembly having electrically isolated conductive coatings at one or more of the coated substrate surfaces, and with each electrically isolated conductive coating or region or portion being selectively and independently accessible or electrically powerable to provide transmission of light through that portion or portions so that information or light emanating from the respective display or displays may pass through the reflective element for viewing by the driver of the vehicle when the mirror assembly is normally mounted in the vehicle and when the driver is normally operating the vehicle. Although shown and described as having locally accessible and powerable regions in front of a display unit, it is envisioned that the mirror reflective element assembly may have such locally accessible and powerable electrically isolated regions disposed or established in front of photosensors or cameras or the like, whereby, when the localized region or regions are powered, light may pass through the reflective element assembly to be received by a photosensor or camera, such as for determining ambient or glare light at the mirror reflective element assembly (whereby the degree of reflectivity/transmissivity of the reflective element assembly may be adjusted responsive to such a photosensor or camera) and/or for capturing images of the interior cabin of the vehicle and/or for capturing images through the rear window of the vehicle of the area rearward of the vehicle.

Thus, the present invention provides for separation of the mirror reflective element assembly into two or more isolated or individually accessible regions or areas. The isolated individual areas may be selectively and individually (or in combination or tandem) switched between their reflective and transmissive states. The video display area can be fully transmissive while the remainder of the mirror remains in the reflective state. The enhanced transmission or greater transmission range of the liquid crystal mirror reflective element assembly of the present invention substantially reduces the requirements of the display backlight output while retaining a mirror-like reflective surface or appearance for viewing by the driver of the vehicle.

Thus, the reflective element assembly of the present invention may comprise three glass substrates with opposing surfaces coated with a conductive coating (such as a transparent electrically conductive coating) and with liquid crystal polarization units disposed between opposed surfaces of the substrates. For example, the rear surface 12b of front substrate 12 and the front and rear surfaces 13a, 13b of the intermediate substrate 13 and the front surface 14a of the rear substrate each may include one or more transparent electrically conductive layers (such as an indium tin oxide (ITO) layer, or a doped indium tin oxide layer or any other transparent electrically semi-conductive layer or coating or the like (such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety) thereat. The coated surfaces or substrates may also be coated to define tab-out regions (such as by utilizing aspects of the mirror assemblies described in U.S. Pat. Nos. 7,274,501; 7,184,190 and/or 7,255,451, which are hereby incorporated herein by reference in their entireties) for providing electrical connection of the conductive layers 18, 19, 20, 21 (or isolated portions or regions thereof) to an electrical clip of connector or bus-bar, such as the types described in U.S. Pat. Nos. 5,066,112 and 6,449,082, which are hereby incorporated herein by reference in their entireties.

The present invention thus enables utilization of more economical backlighting for the likes of video screens used in video mirrors. Because of the high transmission of light through the display region of the reflective element (such at least about 70 percent of visible light therethrough, more preferably at least about 80 percent of visible light therethrough and more preferably at least about 90 percent of visible light therethrough), which is locally electrically addressable and achievable at the region of the subject reflective element at the locale behind which the likes of a backlit thin film transistor (TFT) video screen is disposed, the backlighting intensity that backlights to the rear of the liquid crystal display screen used may have a backlighting intensity of less than about 15,000 cd/m², preferably less than about 10,000 cd/m², and more preferably less than about 6,000 cd/m². Thus, with the high transmissivity benefits of the reflective element assembly of the present invention, a backlighting intensity of, for example, about 1,000 cd/m² to about 10,000 cd/m², more preferably about 2,000 cd/m² to about 8,000 cd/m² and more preferably about 3,000 cd/m² to about 6,000 cd/m², can be utilized. This compares favorably to the backlighting intensity currently common for commercially available electrochromic video mirrors, where backlighting intensities of at least about 30,000 cd/m² are used. Thus, the present invention allows for a reduced backlighting intensity (and reduced power requirements and heat generation that may be associated therewith) for backlit video display screens in video mirror applications, while providing specular reflection at the reflective element when the display device is not activated.

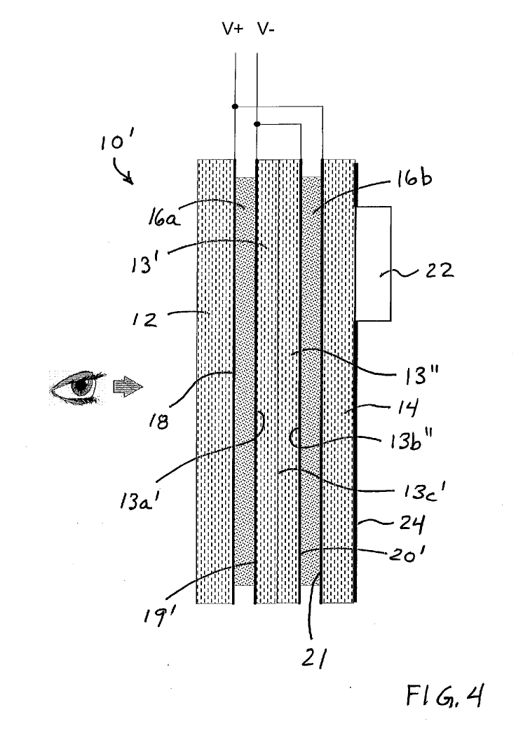

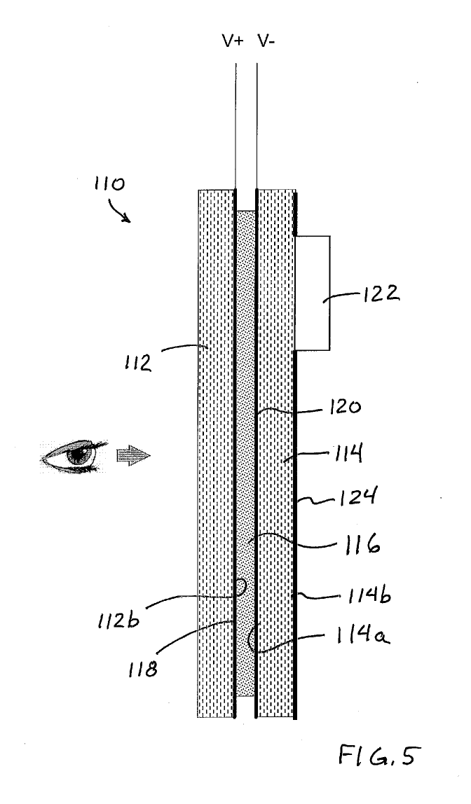

Optionally, and with reference to FIG. 4, a reflective element assembly 10′ may include a pair of intermediate substrates 13′, 13″ sandwiched together or adhered together (such as via a suitable optically matching adhesive 13c′ or the like), with a forward face 13a′ of one of the substrates 13′ having a transparent conductive coating or layer 19′ disposed thereat and contacting the polarization unit 16a′, and with the rearward face 13b″ of the other intermediate substrate 13″ having a transparent conductive coating or layer 20′ disposed thereat and contacting the polarization unit 16b′. Such a double pane intermediate substrate may allow for utilization of single-sided coated substrates that are adhered together to establish the coating at opposite sides of the intermediate substrate of the reflective element assembly 10′. The reflective element assembly 10′ may otherwise be substantially similar to reflective element assembly 10, discussed above, such that a detailed discussion of the reflective element assemblies or cells need not be repeated herein. Similar or common components and/or elements of the mirror reflective element assemblies are shown with like reference numbers in FIGS. 1 and 4.

Optionally, and with reference to FIG. 5, a reflective element assembly 110 may include a single liquid crystal medium or polarization unit 116 disposed between a front glass substrate 112 and a rear glass substrate 114 of the reflective element assembly 110. The rear surface 112b of the glass substrate 112 has a transparent electrically conductive coating or layer 118 disposed or established thereat, while a front surface 114a of the rear substrate 114 has a transparent electrically conductive coating or layer 120 disposed or established thereat. Thus, and in a similar manner as discussed above, when a voltage is applied across the transparent electrically conductive coatings or layers 118, 120, the liquid crystal polarization unit 116 switches from its polarizing state (the reflective element's reflective state) toward or to its transmissive state (such as for displaying information by a display device 122 that is viewable through the liquid crystal polarization unit 116 and through the glass substrate 112). In the illustrated embodiment, a dark or black or opaque or substantially opaque light absorbing coating or layer or film or element or ink 124 is disposed at the rear surface 114b of rear substrate 114 except at the location where the display device 122 is disposed, such as discussed above.

The reflective element assembly 110 thus provides a mirrored or reflective surface or medium that, when in its unpowered state, reflects a substantial amount of light incident thereon, while, when powered, may transmit a substantial amount of light therethrough. For example, when unpowered, the liquid crystal medium or material may reflect around 50 percent of light incident thereon, while when powered, the liquid crystal medium may transmit light therethrough, and may achieve enhanced transmission of light therethrough (such as preferably at least about 60 percent transmissive of light therethrough, and more preferably about 70 percent transmissive of light therethrough, and more preferably about 80 percent or more transmissive of light therethrough), such that the output requirements of the display device are reduced as compared to known electrochromic mirror and display systems. The degree of powering also functions to limit or reduce reflectivity of the mirror reflective element, such as for nighttime driving conditions, such as described above. The reflective element assembly 110 may operate in a similar manner as discussed above (and may operate at an operating current of around 25 mA), such that a detailed discussion of the reflective element assemblies need not be repeated herein.

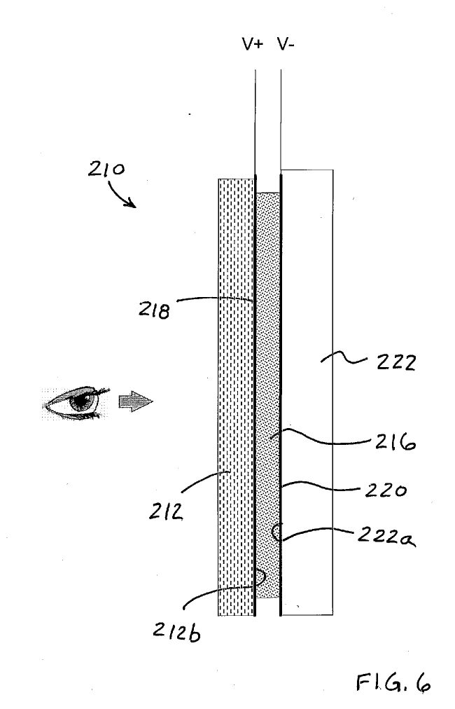

Optionally, and with reference to FIG. 6, a reflective element assembly 210 may include a liquid crystal display device 222 disposed behind a liquid crystal medium or polarization unit 216, which in turn is disposed behind a glass substrate 212 of the reflective element assembly 210. The rear surface 212b of the glass substrate 212 has a transparent electrically conductive coating or layer 218 disposed or established thereat, while a front surface 222a of the liquid crystal display device 222 has a transparent electrically conductive coating or layer 220 disposed or established thereat. Thus, and in a similar manner as discussed above, when a voltage is applied across the transparent electrically conductive coatings or layers 218, 220, the liquid crystal polarization unit 216 switches from its polarizing state (the reflective element's reflective state) toward or to its transmissive state (such as for displaying information by the display device that is viewable through the liquid crystal polarization unit 216 and through the glass substrate 212). In the illustrated embodiment, the liquid crystal display (LCD) device 222 spans substantially across or substantially encompasses the rear surface of the liquid crystal polarization unit 216 and/or front glass substrate 212. Thus, when the LCD device 222 is deactivated, its front surface (or portions thereof) acts as a darkened layer or the like to limit viewing through the reflective element when the reflective element is partially activated so as to not be fully or substantially reflective (such as when the reflective element assembly is dimmed for nighttime driving conditions or the like). The reflective element assembly 210 may operate in a similar manner as discussed above, such that a detailed discussion of the reflective element assemblies need not be repeated herein.

Optionally, the reflective element may include a metallic perimeter band around the perimeter of the reflective element, such as around the perimeter of the rear surface of the front substrate, such as by utilizing aspects of the reflective elements described in U.S. Pat. Nos. 7,626,749; 7,274,501; 7,184,190; and/or 7,255,451, and/or U.S. patent application Ser. No. 11/226,628, filed Sep. 14, 2005 (Attorney Docket DON01 P-1236), which are hereby incorporated herein by reference in their entireties. Optionally, the perimeter band may comprise a chrome/chromium coating or metallic coating and may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. No. 7,184,190 and/or 7,255,451, which are hereby incorporated herein by reference in their entireties). Optionally, the mirror reflective element may comprise a frameless reflective element (such as a frameless exterior mirror assembly or a frameless interior mirror assembly), such as by utilizing aspects of the reflective elements described in U.S. Pat. Nos. 7,626,749; 7,360,932; 7,289,037; 7,255,451; 7,274,501; and/or 7,184,190, and/or PCT Application No. PCT/US2010/32017, filed Apr. 22, 2010, and/or PCT Application No. PCT/US10/51741, filed Oct. 7, 2010, and/or U.S. patent application Ser. No. 11/226,628, filed Sep. 14, 2005 (Attorney Docket DON01 P-1236); and/or Ser. No. 10/538,724, filed Jun. 13, 2005 and published Mar. 9, 2006 as U.S. Publication No. US-2006-0050018-A1, and/or U.S. Des. Pat. Nos. D633,423 and/or D633,019, which are hereby incorporated herein by reference in their entireties.

Typically, the material for the substrates comprises glass, such as soda-lime glass or the like, but other materials, such as polycarbonate or other polymeric materials may be utilized without affecting the scope of the present invention. Although shown as having generally flush edges, the cells manufactured by the process of the present invention may have generally or substantially flush edges or offset edges or overhang regions or the like, while remaining within the spirit and scope of the present invention, such as the types of cells described in U.S. Pat. Nos. 7,274,501; 7,184,190; and/or 7,255,451, which are hereby incorporated herein by reference in their entireties, or may have other forms or shapes, such as the mirror shapes described in U.S. Pat. No. 7,110,156, and/or shown in U.S. Des. Pat. Nos. D493,131 and/or D493,394, which are hereby incorporated herein by reference in their entireties.

Optionally, for example, the substrate surface of the front and/or intermediate and/or rear substrates may be initially coated with a transparent electrically conductive coating, such as a low cost tin oxide coating or the like, such as the types described in U.S. Pat. Nos. 6,420,036; 6,245,262; 6,154,306; and/or 5,724,187, which are hereby incorporated herein by reference in their entireties. For example, a mirror assembly manufacturer may purchase tin oxide-coated glass substrates or sheets, such as sold by the LOF Glass division of Libbey-Owens-Ford Co., Toledo, Ohio under the trade name of “TEC-Glass” products, such as “TEC 10” (10 ohms per square sheet resistance), “TEC 12” (12 ohms per square sheet resistance), “TEC 15” (15 ohms per square sheet resistance) and “TEC 20” (20 ohms per square sheet resistance) tin oxide-coated glass and the like. Moreover, tin oxide coated glass substrates, such as commercially available from Pittsburgh Plate Glass Industries, Pittsburgh, Pa. under the “SUNGATE” trade name, may be advantageously employed herein.

Optionally, the display or displays disposed rearward and behind the rear substrate of the reflective element assembly may comprise a display such as the types disclosed in U.S. Pat. Nos. 7,855,755; 5,530,240; 6,329,925; 7,626,749; 7,581,859; 7,338,177; 7,274,501; 7,255,451; 7,195,381; 7,184,190; 5,668,663; 5,724,187 and/or 6,690,268, and/or in U.S. patent application Ser. No. 11/226,628, filed Sep. 14, 2005 (Attorney Docket DON01 P-1236); and/or Ser. No. 10/538,724, filed Jun. 13, 2005 and published Mar. 9, 2006 as U.S. Publication No. US-2006-0050018-A1, which are all hereby incorporated herein by reference in their entireties. The display is viewable through the reflective element when the liquid crystal units are energized to allow light to pass through at the display region, while the display area of the reflective element assembly still functions to substantially reflect light when the liquid crystal units are not energized, in order to provide a generally uniform reflective element even in the areas that have display elements positioned behind the reflective element. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and/or 6,124,886, and/or U.S. patent application Ser. No. 10/538,724, filed Jun. 13, 2005 and published Mar. 9, 2006 as U.S. Publication No. US-2006-0050018-A1, which are hereby incorporated herein by reference in their entireties.

The display may comprise a video display and may utilize aspects of the video display devices or modules described in U.S. Pat. Nos. 6,690,268; 7,184,190; 7,274,501; 7,370,983; 7,855,755; and/or 7,446,650, and/or U.S. patent application Ser. No. 10/538,724, filed Jun. 13, 2005 and published Mar. 9, 2006 as U.S. Publication No. US-2006-0050018-A1, which are all hereby incorporated herein by reference in their entireties. The video display may be operable to display images captured by one or more imaging sensors or cameras at the vehicle. The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,123,168; 7,004,606; 6,946,978; 7,038,577; 6,353,392; 6,320,176; 6,313,454; and/or 6,824,281, which are all hereby incorporated herein by reference in their entireties. The camera or camera module may comprise any suitable camera or imaging sensor, and may utilize aspects of the cameras or sensors described in U.S. patent applications, Ser. No. 12/091,359, filed Apr. 24, 2008 (Attorney Docket MAG04 P-1299); and/or Ser. No. 10/534,632, filed May 11, 2005 and published Aug. 3, 2006 as U.S. Patent Publication No. US-2006-0171704A1 (Attorney Docket DON01 P-1118); and/or U.S. Pat. No. 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,720,580; 7,339,149; 7,038,577; and/or 7,004,606, and/or U.S. patent application Ser. No. 10/534,632, filed May 11, 2005 and published Aug. 3, 2006 as U.S. Patent Publication No. US-2006-0171704A1 (Attorney Docket DON01 P-1118), and/or PCT Application No. PCT/US2008/076022, filed Sep. 11, 2008 and published Mar. 19, 2009 as International Publication No. WO/2009/036176, and/or PCT Application No. PCT/US2008/078700, filed Oct. 3, 2008 and published Apr. 9, 2009 as International Publication No. WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. patent application Ser. No. 10/538,724, filed Jun. 13, 2005 and published Mar. 9, 2006 as U.S. Publication No. US-2006-0050018-A1, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. patent applications, Ser. No. 11/226,628, filed Sep. 14, 2005 (Attorney Docket DON01 P-1236), and/or Ser. No. 12/578,732, filed Oct. 14, 2009 (Attorney Docket DON01 P-1564), which are hereby incorporated herein by reference in their entireties.

The reflective element assembly of the present invention is suitable for applications with interior rearview mirror assemblies and/or exterior rearview mirror assemblies for vehicles. For interior mirror applications, the mounting assembly of the mirror assembly attached to an interior portion of the vehicle, such as to an inner surface of a vehicle windshield (such as to a mounting button or attachment element adhered to the interior surface of the vehicle windshield). The mirror assembly may be mounted at or attached to an interior portion of the vehicle (such as to a mounting button or the like at an interior surface of the vehicle windshield or the like) via any mounting means, such as a single ball or single pivot mounting arrangement, or a double ball or double pivot mirror mounting arrangement. Examples of double pivot or double ball mounting arrangements are described in commonly assigned U.S. Pat. Nos. 4,646,210 and 6,331,066, which are hereby incorporated herein by reference in their entireties. The mounting assembly may be mounted to a mounting button or attachment element at the vehicle windshield via a breakaway mounting construction, such as by utilizing aspects of the mounting constructions described in U.S. Pat. Nos. 6,774,810; 6,642,851; 6,483,438; 6,366,213; 6,326,900; 6,222,460; 6,172,613; 6,087,953; 5,820,097; 5,377,949; 5,330,149 and/or 5,100,095, which are hereby incorporated herein by reference in their entireties. The mounting assembly may utilize aspects of the mounting assemblies described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860; and/or 6,483,438, and/or U.S. patent application Ser. No. 11/226,628, filed Sep. 14, 2005 (Attorney Docket DON01 P-1236); and/or Ser. No. 12/912,253, filed Oct. 26, 2010 (Attorney Docket DON01 P-1646), and/or PCT Application No. PCT/US10/28130, filed Mar. 22, 2010, which are hereby incorporated herein by reference in their entireties). Optionally, the mirror assembly may incorporate a mounting arrangement of the types described in U.S. Pat. Nos. 7,289,037; 7,249,860; and/or 7,448,589, and/or U.S. patent application Ser. No. 10/522,446, filed Jan. 19, 2005 and published Nov. 10, 2005 as U.S. Patent Publication No. 2005-0248168, which are hereby incorporated herein by reference in their entireties.

Optionally, the mirror assembly may include a compass system and compass circuitry, such as a compass system utilizing aspects of the compass systems described in U.S. Pat. Nos. 7,289,037; 7,249,860; 7,004,593; 6,642,851; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; and/or 6,513,252, and/or European patent application, published Oct. 11, 2000 under Publication No. EP 0 1043566, which are all hereby incorporated herein by reference in their entireties. The compass circuitry may include compass sensors, such as a magneto-responsive sensor, such as a magneto-resistive sensor, a magneto-capacitive sensor, a Hall sensor, a magneto-inductive sensor, a flux-gate sensor or the like. The sensor or sensors may be positioned at and within a base portion of the mirror assembly so that the sensor/sensors is/are substantially fixedly positioned within the vehicle, or may be attached or positioned within the mirror casing. Note that the magneto-responsive sensor used with the mirror assembly may comprise a magneto-responsive sensor, such as a magneto-resistive sensor, such as the types disclosed in U.S. Pat. Nos. 5,255,442; 5,632,092; 5,802,727; 6,173,501; 6,427,349; and/or 6,513,252 (which are hereby incorporated herein by reference in their entireties), or a magneto-inductive sensor, such as described in U.S. Pat. No. 5,878,370 (which is hereby incorporated herein by reference in its entirety), or a magneto-impedance sensor, such as the types described in PCT Publication No. WO 2004/076971, published Sep. 10, 2004 (which is hereby incorporated herein by reference in its entirety), or a Hall-effect sensor, such as the types described in U.S. Pat. Nos. 6,278,271; 5,942,895 and/or 6,184,679 (which are hereby incorporated herein by reference in its entirety). The sensor circuitry and/or the circuitry in the mirror housing and associated with the sensor may include processing circuitry. For example, a printed circuit board may include processing circuitry which may include compensation methods, such as those described in U.S. Pat. Nos. 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; and/or 6,642,851, which are all hereby incorporated herein by reference in their entireties. The compass sensor may be incorporated in or associated with a compass system and/or display system for displaying a directional heading of the vehicle to the driver, such as a compass system of the types described in U.S. Pat. Nos. 5,924,212; 4,862,594; 4,937,945; 5,131,154; 5,255,442; 5,632,092; 7,289,037 and/or 7,004,593, which are all hereby incorporated herein by reference in their entireties.

Optionally, the mirror assembly may include user inputs that may comprise buttons or switches for controlling or activating/deactivating one or more electrical accessories or devices of or associated with the mirror assembly. The mirror assembly may comprise any type of switches or buttons, such as touch or proximity sensing switches, such as touch or proximity switches of the types described above, or the inputs may comprise other types of buttons or switches, such as those described in U.S. Pat. Nos. 6,001,486; 6,310,611; 6,320,282; 6,627,918; 6,690,268; 7,224,324; 7,249,860; 7,253,723; 7,255,451; 7,360,932; and/or 7,446,924, and/or U.S. patent application Ser. No. 10/538,724, filed Jun. 13, 2005 and published Mar. 9, 2006 as U.S. Publication No. US-2006-0050018-A1, and/or Ser. No. 12/576,550, filed Oct. 12, 2009 (Attorney Docket DON01 P-1562), which are all hereby incorporated herein by reference in their entireties, or such as fabric-made position detectors, such as those described in U.S. Pat. Nos. 6,504,531; 6,501,465; 6,492,980; 6,452,479; 6,437,258; and/or 6,369,804, which are hereby incorporated herein by reference in their entireties.

Optionally, the user inputs or buttons may comprise user inputs for a garage door opening system, such as a vehicle based garage door opening system of the types described in U.S. Pat. Nos. 6,396,408; 6,362,771; 7,023,322; and/or 5,798,688, which are hereby incorporated herein by reference in their entireties. The user inputs may also or otherwise function to activate and deactivate a display or function or accessory, and/or may activate/deactivate and/or commence a calibration of a compass system of the mirror assembly and/or vehicle. The compass system may include compass sensors and circuitry within the mirror assembly or within a compass pod or module at or near or associated with the mirror assembly. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; 6,420,975; 6,477,464; 6,946,978; 7,657,052; 7,308,341; 7,167,796; 7,004,593; and/or 6,678,614, and/or U.S. patent application Ser. No. 10/538,724, filed Jun. 13, 2005 and published Mar. 9, 2006 as U.S. Publication No. US-2006-0050018-A1, which are all hereby incorporated herein by reference in their entireties.

Optionally, the mirror assembly may include one or more other accessories at or within the mirror casing or otherwise associated with or near the mirror assembly, such as one or more electrical or electronic devices or accessories, such as antennas, including global positioning system (GPS) or cellular phone antennas, such as disclosed in U.S. Pat. No. 5,971,552, a communication module, such as disclosed in U.S. Pat. No. 5,798,688, a blind spot detection system, such as disclosed in U.S. Pat. Nos. 5,929,786 and/or 5,786,772, transmitters and/or receivers, such as a garage door opener or the like, a digital network, such as described in U.S. Pat. No. 5,798,575, a high/low headlamp controller, such as disclosed in U.S. Pat. Nos. 5,796,094 and/or 5,715,093 and/or U.S. provisional application Ser. No. 61/785,565, filed May 15, 2009, a memory mirror system, such as disclosed in U.S. Pat. No. 5,796,176, a hands-free phone attachment, a video device for internal cabin surveillance and/or video telephone function, such as disclosed in U.S. Pat. Nos. 5,760,962 and/or 5,877,897, a remote keyless entry receiver, lights, such as map reading lights or one or more other lights or illumination sources, such as disclosed in U.S. Pat. Nos. 6,690,268; 5,938,321; 5,813,745; 5,820,245; 5,673,994; 5,649,756; 5,178,448; 5,671,996; 4,646,210; 4,733,336; 4,807,096; 6,042,253; 5,669,698; 7,195,381; 6,971,775; and/or 7,249,860, microphones, such as disclosed in U.S. Pat. Nos. 7,657,052; 6,243,003; 6,278,377; and/or 6,420,975, speakers, antennas, including global positioning system (GPS) or cellular phone antennas, such as disclosed in U.S. Pat. No. 5,971,552, a communication module, such as disclosed in U.S. Pat. No. 5,798,688, a voice recorder, a blind spot or object detection system, such as disclosed in U.S. Pat. Nos. 5,929,786; 5,786,772; 7,720,580; 7,492,281; 7,038,577 and/or 6,882,287; and/or U.S. patent application Ser. No. 12/446,507, filed Apr. 21, 2009 (Attorney Docket DON09 P-1382), transmitters and/or receivers, such as for a garage door opener or a vehicle door unlocking system or the like (such as a remote keyless entry system), a digital network, such as described in U.S. Pat. No. 5,798,575, a high/low headlamp controller, such as a camera-based headlamp control, such as disclosed in U.S. Pat. Nos. 5,796,094 and/or 5,715,093, and/or U.S. provisional application Ser. No. 61/785,565, filed May 15, 2009, a memory mirror system, such as disclosed in U.S. Pat. No. 5,796,176, a hands-free phone attachment, an imaging system or components or circuitry or display thereof, such as an imaging and/or display system of the types described in U.S. Pat. Nos. 7,881,496; 7,526,103; 7,400,435; 6,690,268 and/or 6,847,487, and/or U.S. patent application Ser. No. 12/578,732, filed Oct. 14, 2009 (Attorney Docket DON01 P-1564); and/or Ser. No. 12/508,840, filed Jul. 24, 2009 (Attorney Docket MAG04 P-1541), an alert system, such as an alert system of the types described in PCT Application No. PCT/US2010/25545, filed Feb. 26, 2010, a video device for internal cabin surveillance (such as for sleep detection or driver drowsiness detection or the like) and/or video telephone function, such as disclosed in U.S. Pat. Nos. 5,760,962 and/or 5,877,897, a remote keyless entry receiver, a seat occupancy detector, a remote starter control, a yaw sensor, a clock, a carbon monoxide detector, status displays, such as displays that display a status of a door of the vehicle, a transmission selection (4 wd/2 wd or traction control (TCS) or the like), an antilock braking system, a road condition (that may warn the driver of icy road conditions) and/or the like, a trip computer, a tire pressure monitoring system (TPMS) receiver (such as described in U.S. Pat. Nos. 6,124,647; 6,294,989; 6,445,287; 6,472,979; 6,731,205; and/or 7,423,522, and/or U.S. provisional application Ser. No. 60/611,796, filed Sep. 21, 2004), and/or an ONSTAR® system, a compass, such as disclosed in U.S. Pat. Nos. 5,924,212; 4,862,594; 4,937,945; 5,131,154; 5,255,442; and/or 5,632,092, a control system, such as a control system of the types described in PCT Application No. PCT/US10/038,477, filed Jun. 14, 2010, and/or any other accessory or circuitry or the like (with the disclosures of the above-referenced patents and patent applications and provisional applications and PCT applications being hereby incorporated herein by reference in their entireties).

The accessory or accessories may be positioned at or within the mirror casing and may be included on or integrated in the printed circuit board positioned within the mirror casing, such as along a rear surface of the reflective element or elsewhere within a cavity defined by the casing, without affecting the scope of the present invention. The user actuatable inputs described above may be actuatable to control and/or adjust the accessories of the mirror assembly/system and/or an overhead console and/or an accessory module/windshield electronics module and/or the vehicle. The connection or link between the controls and the systems or accessories may be provided via vehicle electronic or communication systems and the like, and may be connected via various protocols or nodes, such as BLUETOOTH®, SCP, UBP, J1850, CAN J2284, Fire Wire 1394, MOST, LIN, FLEXRAY™, Byte Flight and/or the like, or other vehicle-based or in-vehicle communication links or systems (such as WIFI and/or IRDA) and/or the like, depending on the particular application of the mirror/accessory system and the vehicle. Optionally, the connections or links may be provided via wireless connectivity or links, such as via a wireless communication network or system, such as described in U.S. Pat. No. 7,004,593, which is hereby incorporated herein by reference in its entirety, without affecting the scope of the present invention.

Optionally, a reflective element assembly of the present invention (such as for an interior or exterior rearview mirror assembly) may include a photo sensor or light sensor (such as the types described in U.S. Pat. Nos. 6,831,268; 6,742,904; 6,737,629; 5,406,414; 5,253,109; 4,799,768; 4,793,690; and/or 7,004,593, which are hereby incorporated herein by reference in their entireties) at the rear or fourth surface of the reflective element assembly, such that the photo sensor detects light passing through the reflective element assembly. Examples of such configurations are described in U.S. Pat. Nos. 4,793,690; 5,550,677; 5,193,029 and/or 7,004,593, which are all hereby incorporated herein by reference in their entireties. The reflective element assembly thus may have a window or transmissive port or portion at the photo sensor. The reflective element assembly may have a fixed attenuation such that only a relatively small amount of light passes therethrough, such as about 12 to 25 percent of the light incident on the reflective element assembly, such that the signal to dark current ratio generated at the sensor may be substantially reduced. Because the photo sensor may have a relatively small sensing area, the sensor may not receive or sense a substantial amount of light passing through the reflective element assembly. Therefore, it is envisioned that a light concentrator (such as a lens and/or light channel and/or light pipe and/or other light concentrating device) may be positioned at the photo sensor to focus or direct the light passing through a larger area of the reflective element assembly onto the smaller sensing area of the photo sensor.

Note that mirror cells or reflective element assemblies such as described herein can be included in complete mirror assemblies that include a variety of added-features, such as lighting, telematics functionality and electronics, such as are disclosed in U.S. Pat. Nos. 7,657,052; 7,308,341; 7,195,381; 7,167,796; 7,004,593; 6,690,268; 6,477,464; 6,472,979; 6,445,287; 6,420,975; 6,294,989; 6,278,377; 6,243,003; 6,042,253; 5,938,321; 5,924,212; 5,813,745; 5,820,245; 5,669,698; 5,673,994; 5,671,996; 5,649,756; 5,632,092; 5,255,442; 5,178,448; 5,131,154; 4,937,945; 4,862,594; 4,807,096; 4,733,336; and/or 4,646,210, which are all hereby incorporated herein by reference in their entireties.

Changes and modifications in the specifically described embodiments may be carried out without departing from the principles of the present invention, which is intended to be limited only by the scope of the appended claims, as interpreted according to the principles of patent law.

What is claimed is:

1. A variable reflectance vehicular mirror reflective element assembly comprising:
a front substrate having a front surface that generally faces a driver of a vehicle equipped with a mirror assembly that incorporates said rearview mirror reflective element assembly;
said front substrate having a rear surface opposite said front surface, wherein said rear surface of said front substrate has a transparent electrically conductive coating disposed thereat;
an intermediate substrate having a front surface and a rear surface, wherein said front surface of said intermediate substrate has a conductive coating disposed thereat and said rear surface of said intermediate substrate has a conductive coating disposed thereat;
a rear substrate having a front surface and a rear surface, wherein said front surface of said rear substrate has a conductive coating disposed thereat;
a first liquid crystal polarization unit disposed between said rear surface of said front substrate and said front surface of said intermediate substrate;
a second liquid crystal polarization unit disposed between said rear surface of said intermediate substrate and said front surface of said rear substrate;
wherein said first liquid crystal polarization unit, when unpowered, functions to polarize light in a first direction and said second liquid crystal polarization unit, when unpowered, functions to polarize light in a second direction, and wherein said second direction is generally opposite said first direction;
wherein, when said first and second liquid crystal polarization units are unpowered, said reflective element assembly substantially specularly reflects light incident thereon so as to appear specularly mirror-like to the driver viewing said front surface of said front substrate when said reflective element assembly is normally mounted in the equipped vehicle;
wherein, when said first and second liquid crystal polarization units are electrically powered, said first and second liquid crystal polarization units change from being highly specularly reflective to substantially transmitting visible light therethrough, and wherein, when said first and second liquid crystal polarization units are electrically powered, the driver viewing said front surface essentially sees through both said first and second liquid crystal polarization units to a light absorbing layer established at said rear substrate and behind said first and second liquid crystal polarization units; and
wherein, when powered, said first and second liquid crystal polarization units cooperate or combine to provide an anti-glare, low reflecting mirror for viewing by the driver of the equipped vehicle.

2. The variable reflectance vehicular mirror reflective element assembly of claim 1, wherein said first liquid crystal polarization unit, when unpowered, polarizes light passing therethrough in a right or left circular direction and wherein said second liquid crystal polarization unit, when unpowered, polarizes light passing therethrough in a left or right circular direction.

3. The variable reflectance vehicular mirror reflective element assembly of claim 1, further comprising a display device disposed behind said rear substrate and operable to display information, wherein said first and second liquid crystal polarization units are operable to, when powered, substantially transmit light therethrough so display information emitted by said display device is viewable through said reflective element assembly by the driver of the equipped vehicle, and wherein said light absorbing layer is not established at said rear substrate in the localized area at which said display device is disposed.

4. A variable reflectance vehicular mirror reflective element assembly comprising:
a front substrate having a front surface that generally faces a driver of a vehicle equipped with a mirror assembly that incorporates said rearview mirror reflective element assembly;
said front substrate having a rear surface opposite said front surface, wherein said rear surface of said front substrate has a transparent electrically conductive coating disposed thereat;
a rear substrate having a front surface and a rear surface, wherein said front surface of said rear substrate has a conductive coating disposed thereat;
a liquid crystal polarization unit disposed between said rear surface of said front substrate and said front surface of said rear substrate;
wherein said liquid crystal polarization unit, when unpowered, functions to polarize light passing therethrough;
wherein, when said liquid crystal polarization unit is unpowered, said reflective element assembly substantially reflects light incident thereon so as to appear mirror-like to the driver viewing said front surface of said front substrate when said reflective element assembly is normally mounted in the equipped vehicle; and
wherein, when said liquid crystal polarization unit is electrically powered, said liquid crystal polarization unit changes from being highly specularly reflective to substantially transmitting visible light therethrough, and wherein, when said liquid crystal polarization unit is electrically powered, the driver viewing said front surface of said front substrate essentially sees through said liquid crystal polarization unit, and wherein, when powered, said liquid crystal polarization unit provides an anti-glare, low reflecting mirror for viewing by the driver of the equipped vehicle.

5. The variable reflectance vehicular mirror reflective element assembly of claim 4, further comprising a light absorbing layer established at said rear substrate and behind said liquid crystal polarization unit.

6. The variable reflectance vehicular mirror reflective element assembly of claim 5, further comprising a display device disposed behind said rear substrate and operable to display information, wherein said liquid crystal polarization unit is operable to, when powered, substantially transmit light therethrough so display information emitted by said display device is viewable through said reflective element assembly by the driver of the equipped vehicle, and wherein said light absorbing layer is not established at said rear substrate in the localized area at which said display device is disposed.

7. The variable reflectance vehicular minor reflective element assembly of claim 4, wherein said rear substrate comprises a display device operable to display information when activated, and wherein a front surface of said display device has said transparent electrically conductive coating disposed thereat.

8. The variable reflectance vehicular mirror reflective element assembly of claim 7, wherein said display device comprises a liquid crystal display device.
